(19) United States
(12) Patent Application Publication
(10) Pub. No.: US 2025/0171659 A1
(43) Pub. Date: May 29, 2025

(54) MULTILAYER ADHESIVE ARTICLES AND METHODS

(71) Applicant: 3M INNOVATIVE PROPERTIES COMPANY, St. Paul, MN (US)

(72) Inventors: Jonathan E. Janoski, Woodbury, MN (US); Andrew Satrijo, St. Paul, MN (US)

(21) Appl. No.: 18/851,193

(22) PCT Filed: Jun. 7, 2023
(86) PCT No.: PCT/IB2023/055873

§ 371 Date: Sep. 26, 2024

Related U.S. Application Data
(60) Provisional application No. 63/356,556, filed on Jun. 29, 2022.

(51) Int. Cl. C09J 7/24; C09J 153/00; C09J 163/00; C09J 167/04; C09J 171/08

(52) U.S. Cl. CPC C09J 7/245; C09J 153/00; C09J 163/00; C09J 167/04; C09J 171/08; C09J 2301/124; C09J 2301/414; C09J 2453/00; C09J 2467/00; C09J 2471/00

(57) ABSTRACT

An article is described comprising a first layer comprising a curable adhesive composition disposed on a second layer comprising polyvinyl acetal polymer. The curable adhesive composition comprises a thermoplastic polymer, such as an acrylic block copolymer; an epoxy resin; and preferably a polyol. Also described are methods and a curable adhesive composition.

### DETAILED DESCRIPTION

In the consumer electronics industry, there is a need for electronic display bonding materials. For example, in mobile phone display bonding, a tape is needed that is resistant to both drops and impacts. Some electronics Original Equipment Manufacturers (“OEMs”) evaluate a tape candidate's drop resistance using a tensile impact test method, whereas other OEMs prioritize dynamic shear test methods. In actual phone device drops, both tensile and shear forces are present, so it is important for a display bonding tape to be resistant to impact forces in both tensile and shear directions.

Another tape property that is important is pushout resistance, which can be tested by debonding two rigid substrates in a slow tensile direction. Properties such as dynamic shear resistance and pushout resistance are generally exhibited by stiff, high-modulus tapes. Unfortunately, during the phone assembly process, stiff high-modulus tapes typically require high pressure and high temperature to make a water-tight seal between two rigid substrates.

### BRIEF DESCRIPTION OF THE DRAWING

FIG. 1 is a schematic drawing of an extrusion process suitable for preparing multilayer adhesive articles.

### SUMMARY

In one embodiment, an article is described comprising a first layer comprising a curable adhesive composition. The curable adhesive composition comprises a thermoplastic polymer and an epoxy resin.

The first layer is disposed on a second (e.g. backing or carrier) layer comprising polyvinyl acetal polymer. Without being bound by theory, it is surmised that the hydroxyl groups of the polyvinyl acetal polymer react with the epoxy groups of the epoxy resin thereby providing good interlayer adhesion between the adhesive of the first layer and the second (e.g. backing or carrier) layer. In some embodiments, the thermoplastic polymer comprises an acrylic block copolymer.

In one favored embodiment, the adhesive composition comprises 20 wt. % to 60 wt. % of an acrylic block copolymer: 5 wt. % to 60 wt. % of an epoxy resin; and 1 wt. % to 60 wt. % of a polyol.

The (e.g. tape) articles are initially soft (i.e., low-modulus), which enables a water-tight seal during the assembly process at room temperature, and then may be UV-cured into a rigid (i.e., high modulus) tape that has a balance of impact resistance (both tensile and shear impact), dynamic shear resistance, and pushout resistance.

In another embodiment, a method of preparing an adhesive article is described comprising: thermal extrusion of a first layer and a second layer, as described herein.

### Thermoplastic Polymer

The curable adhesive comprises a thermoplastic polymer. Thermoplastic polymers can change from a solid to a liquid with heat rather than a solvent. Thus, the curable adhesive composition can advantageously be substantially solvent-free (i.e. less than 1, 0.5 or 0.1 wt. % of organic solvent).

In typical embodiments, the thermoplastic polymer one or more block copolymers, comprising at least two A block polymeric units and at least one B block polymeric unit (i.e., at least two A block polymeric units are each covalently bonded to at least one B block polymeric unit). Each A block is derived from a first (meth)acrylate monomer and the B block is derived from second a (meth)acrylate monomer. The A block tends to be more rigid than the B block (i.e., the A block has a higher glass transition temperature than the B block). The A block is also referred to herein as a “hard block” and the B block is also referred to herein as a “soft block.” Acrylic block copolymers are differentiated from other acrylic copolymers in that they exhibit phase segregation at temperatures lower than the glass transition temperature of the end blocks. This leads to elastomeric properties below that temperature and the ability to compound solvent-free above that temperature. A consequence of this behavior may be superior roll stability and static shear performance of materials compounded with acrylic block copolymers compared to their random acrylic copolymer counterparts. In some embodiments, the (e.g. acrylic) block copolymer comprises an A-B-A triblock copolymers.

In some embodiments, the (e.g. acrylic) block copolymer comprises at least 7, 8, 9 or 10 wt. % and no greater than 51 wt. % of hard blocks (“A block”) and 49 wt. % to 93 wt. % of a soft block (“B block”) based on the weight of the block copolymer. In some embodiments, the (e.g. acrylic) block copolymer comprises at least 15 or 20 wt. % of hard block. In some embodiments, the (e.g. acrylic) block copolymer comprises no greater than 45, 40, or 25 wt. % of hard block. Higher amounts of the A block tend to increase the stiffness or modulus of the copolymer, which can be used to optimize properties of the composition such as the mechanical strength and modulus.

In some preferred embodiments, one or both of the blocks is non-reactive during the UV-activated epoxy reaction (e.g. one or both blocks does not contain pendant epoxy or hydroxyl functionality). In some preferred embodiments, the hard block comprises polymethyl methacrylate. In some preferred embodiments, the soft block comprises polybutyl acrylate. Methods of preparing acrylic block copolymers are known to those of skill in the art and are described, for example, in U.S. Pat. No. 6,806,320 (Everaerts et al.). Acrylic block copolymers useful in embodiments of the present disclosure are also commercially available, for example, from Kuraray CO., Tokyo, Japan under the trade designation “KURARITY.”

In some embodiments, the (e.g. acrylic) block copolymer has a weight average molecular weight of at least 30, 40 or 50,000 g/mole as measured with Gel Permeation Chromatography using the test method described in the examples. The (e.g. acrylic) block copolymer typically has a weight average molecular weight no greater than 200,000; 175,000; 150,000; 125,000 or 100,000 g/mole. In some embodiments, the (e.g. acrylic) block copolymer has a weight average molecular weight of at least 60,000; 70,000; 80,000; 90,000 or 100,000 g/mole. In some embodiments, the (e.g. acrylic) block copolymer has a weight average molecular weight of no greater than 100,000; 90,000; 80,000; 70,000; or 60,000 g/mole. In some embodiments, the (e.g. acrylic block copolymer has a number average molecular weight of greater than 102 or 110 kD (i.e. 102,000 or 110,000 g/mole). The curable adhesive composition may comprise a single (e.g. acrylic) block copolymer or a blend of a higher and lower molecular weight copolymers.

Melt flow rate (MFR) is another way to express molecular weight (as determined with ISO 1133). In some embodiments, the (e.g. acrylic) block copolymer has a MFR of at least 2, 3, or 4 g/10 minutes at a temperature of 190° C. and weight of 2.16 kg. In some embodiments, the (e.g. acrylic) block copolymer has a MFR of no greater than 60, 50, 40, or 30 g/10 minutes at a temperature of 190° C. and weight of 2.16 kg. In some embodiments, the MFR of the (e.g. acrylic) block copolymer is at least 5, 10, 15, 20, 25, or 30 g/10 minutes at a temperature of 190° C. and weight of 2.16 kg. In some embodiments, the MFR of the (e.g. acrylic) block copolymer is less than 30, 25, 20, 15, 10, or 5 g/10 min at a temperature of 190° C. and weight of 2.16 kg.

In some embodiments, the curable adhesive composition comprises at least 20, 25, 30, 35, or 40 wt. % of thermoplastic block copolymer, based on the total weight of thermoplastic block copolymer, epoxy resin and polyol. The amount of thermoplastic polymer is typically no greater than 60, 55, or 50 wt. %.

### Epoxy Resin

Curable adhesive compositions include at least 5, 10, 15 or 20 wt. % and no greater than 60, 55, 50, or 45 wt. % of an epoxy resin, based on the total amount of thermoplastic block copolymer, epoxy and polyol. A variety of commercially available epoxy resins can be utilized in curable compositions of the present disclosure. Typically, useful epoxy resins may have an epoxy equivalent weight of from 150 to 250.

In some embodiments, the epoxy resin may comprise a first epoxy resin and a second epoxy resin combined in a ratio of 0.5:1.5, optionally 0.75:1.25, or optionally 1:1. In some embodiments, the second epoxy resin has an epoxy equivalent weight of from about 500 to about 600.

In some preferred embodiments, the epoxy resin comprises a bisphenol A derived epoxy resin. Examples of such preferred epoxy resins include, without limitation, a difunctional bisphenol A/epichlorohydrin derived epoxy resin, commercially available under the trade designation “EPON 828” from Dow Inc., Midland, Michigan, and a difunctional bisphenol A/epichlorohydrin derived epoxy resin, commercially available under the trade designation “EPON 1001F” from Dow Inc., Midland, Michigan.

### Polyol

Curable adhesive compositions described herein comprise a polyol. The term polyol refers to a material having at least two hydroxyl groups and a molecular weight of at least 500, 1000, 1500, or 2000 g/mol and no greater than 14,000 g/mol. Curable adhesive compositions typically comprise at least 1, 2, 3, 4, or 5 wt. % of a polyol and no greater than to 60, 55, or 50 wt. %, based on the total amount of thermoplastic block copolymer, epoxy, and polyol. In some embodiments, the amount of polyol is at least 6, 7, 8, 9, 10, 11, 12, 13, 14, or 15 wt. %, of a polyol.

When higher molecular weight polyols (i.e., polyols having weight average molecular weights of at least about 2,000) are used, it is often desirable that the polyol component be “highly pure” (i.e., the polyol approaches its theoretical functionality—e.g., 2.0 for diols, 3.0 for triols, etc.). Such highly pure polyols generally have a ratio of polyol molecular weight to weight % hydroxyl equivalent weight of at least about 800, typically at least about 1,000, and more typically at least about 1,500. For example, a 12,000 molecular weight polyol with 8 weight % hydroxyl equivalent weight has such a ratio of 1,500 (i.e., 12,000/8=1,500).

Examples of highly pure polyols useful in embodiments of the present disclosure include those available from Covestro AG of Luverkusen, Germany, under the trade designation, ACCLAIM, and certain of those under the trade designation, ARCOL.

### Curing Agent

The curable composition optionally but typically further contains one or more curing agents. The term “curing agent” is used broadly to include not only those materials that are conventionally regarded as curatives but also those materials that catalyze or accelerate the reaction of the curable material, as well as, those materials that may act as both curative and catalyst or accelerator. It is also possible to use two or more curing agents in combination. The curing agent may be a heat-activated curative or a light-activated curative. The cure from a light-10 activated curative can optionally be accelerated by elevated temperature (e.g., 40-80° C.).

In some embodiments, the adhesive comprises a first photoacid curing agent (e.g. 0432 and CPI6976) that absorbs light, and then generates an acid. The acid catalyzes a polymerization of the epoxy groups and polyol. Exposure to light typically occurs after the adhesive is applied to the concrete or pavement. Alternatively, an epoxy curative may also be incorporated into a primer that is applied to a surface. The adhesive is then adhered to the primed surface. In this embodiments, the adhesive may lack curing agent(s). The epoxy groups react with the polyol at a slow rate in the absence of curing agent.

Suitable curing agents for use in embodiments of the present disclosure include, but are not limited to, curing agents disclosed in U.S. Pat. No. 4,503,211 (Robins); U.S. Pat. No. 4,751,138 (Tumey, et al.); and U.S. Pat. No. 10,774,245 (Emslander et al.), the disclosures of all of which are incorporated by reference in their entirety.

The amount of the photoinitiator used in the UV-curable pressure-sensitive adhesive composition in a reactive polyacrylate/epoxy resin hybrid system with reactive functional groups is very small, but the amount thereof has a great impact on the curing speed and storage stability of the UV-curable pressure-sensitive adhesive composition.

The photoinitiator may be a cationic photoinitiator, including but not limited to, onium salts and cationic organometallic salts, both of which are described in U.S. Pat. No. 5,709,948 and photoactivatable organometallic complex salts such as those described in U.S. Pat. Nos. 5,059,701; 5,191,101; and 5,252,694. Suitable cationic photoinitiators including but not limited to the following compounds: diaryl iodonium salt, triaryl sulfonium salt, alkyl sulfonium salt, iron aromatic hydrocarbon salt, sulfonyloxanone, and triaryl siloxane. In some embodiments, the following compounds are used: triarylsulfonium hexafluorophosphate salts or hexafluoroantimonate salts, sulfonium hexafluoroantimonate salts, sulfonium hexafluorophosphate salts, and iodonium hexafluorophosphate salts.

The onium salt photoinitiator applicable to the present invention includes, but not limited to, iodonium and sulfonium complex salts. Suitable aromatic iodonium complex salts are described more fully in U.S. Pat. No. 4,256,828. Useful aromatic iodonium complex salts include a salt of a general formula as follows:

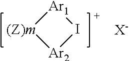

Ar₁ and Ar₂ are identical or different, each comprising aryl having about 4 to 20 carbon atoms. Z is selected from the group consisting of oxygen, sulfur, carbon-carbon bonds;

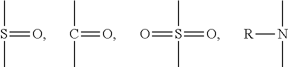

R may be aryl (having about 6 to 20 carbon atoms, such as phenyl) or acyl (having about 2 to 20 carbon atoms, such as acetyl or benzoyl); and

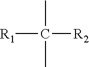

R₁ and R₂ are selected from the group consisting of hydrogen, alkyl having about 1 to 4 carbon atoms, and alkenyl having about 2 to 4 carbon atoms.
m is 0 or 1; and
X has a DQn chemical equation, where D is a metal in families IB to VIII or nonmetal in families from IIIA to VA in the periodic table of elements, or a combination thereof, D also includes hydrogen: Q is halogen atom; and n is an integer within 1 to 6. The metal is preferably copper, zinc, titanium, vanadium, chromium, magnesium, manganese, iron, cobalt, or nickel, and the nonmetal is advantageously boron, aluminium, antimony, tin, arsenic and phosphorus. Halogen Q is preferably chlorine or fluorine. Suitable examples of anions include, but are not limited to, BF₄⁻, PF₆⁻, SbF₆⁻, FeCl₄⁻, SnCl₅⁻, AsF₆⁻, SbF₅OH⁻, SbCl₆⁻, SbF₅⁻², AlF₅⁻², GaCl₄⁻, InF₄⁻, TiF₆⁻², ZrF₆⁻, and CF₃SO₃⁻. The anions are preferably BF₄⁻, PF₆⁻, SbF₆⁻, AsF₆⁻, SbF₅OH⁻, and SbCl₆⁻. More preferably, the anions are SbF₆⁻, AsF₆⁻ and SbF₅OH⁻.

More preferably, Ar₁ and Ar₂ are selected from the group consisting of phenyl group, thienyl group, furanyl group, and pyrazolyl group. The Ar₁ and Ar₂ groups may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

Aromatic sulfonium complex salt initiators applicable to the present invention may be expressed by the following general formula:

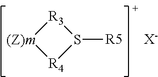

wherein R₃, R₄ and R₅ are identical or different, provided that at least one of R₃, R₄ and R⁵ is aryl. R₃, R₄ and R₅ may be selected from the group consisting of aromatic portions comprising about 4 to 20 carbon atoms (e.g., substituted and unsubstituted phenyl, thienyl and furyl) and alkyl comprising about 1 to 20 carbon atoms. R₃, R₄ and R₅ are each preferably an aromatic portion; and Z, m, and X are all those as defined for the sulfonium complex salt above.

If R₃, R₄ and R₅ are aromatic groups, they may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

In one example of the present invention, triaryl substituted salts such as triphenylsulfonium hexafluoroantimonate, triphenylsulfonium hexafluorophosphate, and p-phenyl (phenylthio) biphenyl sulfonium hexafluoroantimonate are preferred sulfonium salts. Other sulfonium salts useful in the present invention are described more fully in U.S. Pat. Nos. 4,256,828 and 4,173,476.

The onium salt photoinitiators useful in the present invention are photosensitive in the ultraviolet region of the spectrum. However, they can be sensitized to the near ultraviolet and the visible range of the spectrum by sensitizers for known photolyzable organic halogen compounds. Illustrative sensitizers include colored aromatic polycyclic hydrocarbons, as described in U.S. Pat. No. 4,250,053, and sensitizers such as described in U.S. Pat. Nos. 4,256,828 and 4,250,053. Suitable sensitizers should be chosen so as to not interfere appreciably with the cationic cure of the epoxy resin in the adhesive composition.

Another type of photoinitiators applicable to the present invention includes photo-activable organic metallic complex salts, such as those described in U.S. Pat. No. 5,059,701 (Keipert), U.S. Pat. No. 5,191,101 (Palazzotto et al.), and U.S. Pat. No. 5,252,694 (Willett et al.). These organic metal cationic salts have a general formula as follows:

[(L₁)(L₂)Mₘ]e⁺X⁻
where Mₘ represents an element selected from families IVB, VB, VIB, VIIB, and VIII in the periodic table of elements, and is preferably Cr, Mo, W, Mn, Re, Fe or Co; L₁ represents no ligand, or 1 or 2 ligands that contribute π electrons, wherein the ligands may be the same or different, and each ligand may be selected from the group consisting of carbocyclic aromatic and heterocyclic aromatic compounds which are substituted and unsubstituted by substituted and unsubstituted alicyclic and cyclic unsaturated compounds. Each of the compounds may contribute 2 to 12 pi electrons to a valence shell of the metal atom M. L₁ is advantageously selected from the group consisting of substituted and unsubstituted η3-allyl, η5-cyclopentadienyl and η7-cycloheptane compounds, and η6-aromatics from η6-benzene and substituted η6-benzene compounds (e.g., xylene) and compounds with 2-4 fused rings, each ring being able to contribute 3 to 8 π electrons to the valence shell of metal atom M.
L₂ represents no ligand or one to three ligands that contribute an even number of σ electrons, wherein the ligands may be the same or different, and each ligand may be selected from the group consisting of carbon monoxide, nitrite onium, triphenylphosphine, triphenylantimony, and phosphorus, arsenic, antimony derivatives, under the condition that the total charges contributed by L₁ and L₂ to Mₘ result in net residual positive charges to e of a complex.
e is an integer of 1 or 2, the residual charge in coordination with cations; and X is a halogen-containing anion in coordination, as stated above.

Examples of organic metal complex cationic salts suitable for use as the photo-activable catalysts in the present invention include, but not limited to, the following:
[(η6-benzene)(η5-cyclopentadienyl)Fe]⁺[SbF₆]⁻,
[(η6-toluene)(η5-cyclopentadienyl)Fe]⁺[AsF₆]⁻,
[(η6-xylene)(η5-cyclopentadienyl)Fe]⁺[SbF₆]⁻,
[(η6-isopropylbenzene)(η5-cyclopentadienyl)Fe]⁺[SbF₆⁻],
[(η6-xylene (mixed isomer))(η5-cyclopentadienyl)Fe]⁺ [SbF₆⁻],
[(η6-xylene (mixed isomer))(η5-cyclopentadienyl)Fe]⁺[PF₆]⁻,
[(η6-o-xylene)(η5-cyclopentadienyl)Fe]⁺[CF₃SO₃]⁻,
[(η6-m-xylene)(η5-cyclopentadienyl)Fe]⁺[BF₄]⁻,
[(η6-1,3,5-trimethylbenzene)(η5-cyclopentadienyl)Fe]⁺[SbF₆]⁻,
[(η6-hexamethylbenzene)(η5-cyclopentadienyl)Fe]⁺[SbF₅OH]⁻,
[(η6-fluorene) (15-cyclopentadienyl)Fe]⁺ [SbF₆]⁻.

In one example of the present invention, the required organic metal complex cationic salts include one or more of the following compounds:
[(η6-xylene (mixed isomer))(η5-cyclopentadienyl)Fe]⁺[SbF₆]⁻,
[(η6-xylene (mixed isomer))(η5-cyclopentadienyl)Fe]⁺[PF₆]⁻,
[(η6-xylene) (15-cyclopentadienyl)Fe]⁺[SbF₆]⁻,
[(η6-1,3,5-trimethylbenzene)(η5-cyclopentadienyl)Fe]⁺[SbF₆]⁻,

Suitable commercially-available initiators include, but not limited to, DOUBLECURE1176, 1193 (Double Bond Chemical Ind. Co., Ltd.) and IRGACURE™ 261, and cationic organic metallic complex salts (BASF). Photoinitiators include, but not limited to, azo initiators and peroxide initiators, such as azobisisobutyronitrile (AIBN), azodiisoheptanitrile (ABVN), 2,2′-azo-bis-(2-methylbutyronitrile) (AMBN), benzoyl peroxide (BPO), and persulfate.

In the composition of the present invention, the content of the photoinitiator is 0.05 to 5 parts by weight, preferably 1-2 parts by weight. Generally speaking, the curing speed of the adhesive composition increases as a result of an increase of the content of the photoinitiator. When the amount of the used photoinitiator is too low, the required radiation energy of UV during curing is high, and the curing speed is slow. On the contrary, when the amount of the used photoinitiator is too great, the required radiation energy of UV during is very low and the curing speed is too fast. Even under sunlight or fluorescent lamp light (containing a small amount of UV light), the photoinitiator can be cured, thereby impacting the storage stability at room temperature.

Curable compositions of the present disclosure commonly include 0.5 wt. % to 10 wt. %, optionally 0.75 wt. % to 8 wt. %, or optionally 1 wt. % to 0 5 wt. % of a curing agent. Commonly, the curing agent is selected from the group consisting of an amine curing agent, a photoinitiator, and combinations thereof.

### Optional Additives

The curable composition may optionally further contain one or more additives such as, for example, an additive selected from the group consisting of microspheres, a styrenic block copolymer, an epoxidized natural rubber, and combinations thereof. In some preferred embodiments, the curable composition comprises up to 5 wt. % of the microspheres, such as the expandable polymeric microspheres available under the trade designation DUALITE, from Chase Corp., Westwood, MA, USA. In some preferred embodiments, the curable composition comprises 10 wt. % of the styrenic block copolymer. In some preferred embodiments, the curable composition comprises up to 60 wt. % of the epoxidized natural rubber.

Curable compositions may also contain one or more additional conventional additives. Preferred additives may include, for example, tackifiers, plasticizers, dyes, antioxidants, UV stabilizers, and combinations thereof. Such additives can be used if they do not affect the superior properties of the pressure-sensitive adhesives.

If tackifiers are used, then up to 50% by weight, preferably less than 30% by weight, and more preferably less than 5% by weight, based on the dry weight of the curable composition would be suitable. In some embodiments no tackifier is used. Suitable tackifiers for use with (meth)acrylate polymer dispersions include a rosin acid, a rosin ester, a terpene phenolic resin, a hydrocarbon resin, and a cumarone indene resin. The type and amount of tackifier can affect properties such as contactability, bonding range, bond strength, heat resistance and specific adhesion.

Curable composition as disclosed herein may be prepared by methods know to those or ordinary skill in the relevant arts. For example, the curable composition may be prepared by combining the copolymer with an epoxy resin, polyol, curing agent, and optionally coating the mixture. In some embodiments, the combining step comprises melt blending. In some embodiments, the combining step comprises solvent blending.

### Physical Properties of the Adhesive or Article

The physical properties of the adhesive composition and articles can be characterized utilizing various test methods.

The uncured adhesive exhibits good initial pressure sensitive adhesive properties. In some embodiments, the uncured adhesive has an elastic shear modulus (G′) at 5° C. of less than or equal to 1, 0.5 or 0.1 MPa. In some embodiments, the uncured adhesive has a G′ at 23° C. of less than 0.5, 0.2, 0.1, or 0.05 MPa. In some embodiments, the uncured adhesive has a G′ of less than 0.1 MPa for a temperature in the range of 25 to 70° C. The G′ can be lowered by reducing the crosslinking (e.g. polyol) or adding tackifier and/or plasticizer. The G′ can also be lowered by increasing the temperature at which the adhesive is applied.

In some embodiments, the cured adhesive has an elastic modulus E′ at 23° C. of greater than a comparative PSA adhesive. In some embodiments, cured adhesive has an elastic shear modulus (G′) at 5° C. of greater than 0.1, 0.5, 1, 2, 3, 4, 5, 6, 7, 8, 9, 10, 11, 12, 13, or 14 MPa. In some embodiments, cured adhesive has an elastic shear modulus (G′) at 23° C. of greater than 0.05, 0.1, 0.5, 1, 2, 3, 4, 5, 6, 7, 8, 9, or 10 MPa. In some embodiments, cured adhesive has an elastic shear modulus (G′) at 70° C. of greater than 0.05, 0.1, 0.2, 0.3, 0.4, or 0.5, MPa.

In some embodiments, the E′ of the cured adhesive is at least 1E+05 (1×10⁶) Pa, 5E+05 Pa, 1E+06 Pa, 5E+06 Pa, 1E+07 Pa, 5E+07 Pa, 1E+08 Pa. In some embodiment, E′ of the cured adhesive is no greater than 1E+09 Pa or 5E+08 Pa, 1E+08 Pa, 5E+07 Pa, 1E+07 Pa, or 5E+06 Pa.

In some embodiments, the cured adhesive has a Tan(δ) max of less than a comparative adhesive. In some embodiments, the Tan(δ) max is less than 120, 110, 100, 90, or 80° C. In some embodiments, the Tan(δ) max is less than 70, 60, 50, 40, 30 or 20° C. In some embodiments, the Tan(δ) max is at least 10, 20, 30, 40, 50, 60, or 70° C.

In some embodiments, the cured adhesive composition has a gel content of at least 50, 60, 70, 80, or 90 wt. %. In some embodiments, the cured adhesive composition has a static shear of greater than 10,000 minutes. In some embodiments, the cured adhesive composition has an impact strength of 0.4 to 1.8 Joules as measured by Tensile Impact test method. In some embodiments, the cured adhesive composition has a push out strength of 50 to 1040 Joules as measured by Push Out Strength test method. In some embodiments, the cured adhesive composition has a dynamic shear of 0.5 to 7.32 MPa as measured by Dynamic Shear test method.

### Second Layer

Adhesive articles may be prepared by providing the curable adhesive composition on a second (e.g. core) layer comprising polyvinyl acetal polymer. Such second layer may be characterized as a support, (e.g. flexible) backing, or a carrier layer.

Polyvinyl acetal polymers (also referred to as resins) are known and typically obtained by reacting polyvinyl alcohol with aldehyde, as known in the art.

Polyvinyl alcohol resins are not limited by the production method. For example, those produced by saponifying polyvinyl butyrate and the like with alkali, acid, ammonia water, and the like, can be used. Polyvinyl alcohol resins may be either completely saponified or partially saponified. It is preferable to use those having a saponification degree of 80 mol % or more. The polyvinyl alcohol resins may be used singly or in combination of two or more. Aldehydes used in the production of the polyvinyl acetal resin include formaldehyde (including paraformaldehyde), acetaldehyde (including paraacetaldehyde), propionaldehyde, butyraldehyde, n-octylaldehyde, amylaldehyde, hexylaldehyde, heptylaldehyde, 2-ethylhexylaldehyde, cyclohexylaldehyde, furfural, glyoxal, glutaraldehyde, benzaldehyde, 2-methylbenzaldehyde, 3-methylbenzaldehyde, 4-methylbenzaldehyde, p-hydroxybenzaldehyde, m-hydroxybenzaldehyde, phenylacetaldehyde, β-phenylpropionaldehyde, and the like. These aldehydes may be used singly or in combination of two or more.

The polyvinyl acetal resin generally has repeating units represented by Chemical Formula 1.

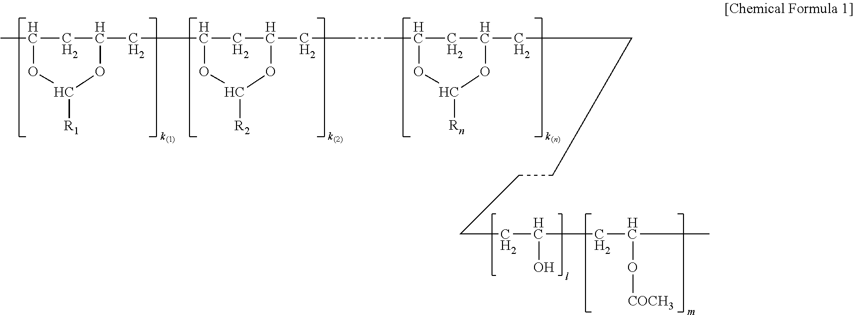

In Chemical Formula 1, n is the number of different types of aldehyde used in acetalization; R₁, R₂, . . . , Rₙ, are independently a (e.g. C1-C7) alkyl residue of aldehyde used in the acetalization reaction, or a hydrogen atom; k₁, k₂, . . . , kₙ are independently the proportion of each acetal unit containing R₁, R₂, . . . , Rₙ, (molar ratio); l is the proportion of vinyl alcohol units (molar ratio); and m is the proportion of vinyl acetate units (molar ratio). The sum of k₁+k₂++kₙ+l+m=1. Further at least one of k₁, k₂, . . . kₙ may not be zero. When a single type of aldehyde is utilized in the preparation of the polyvinyl acetal resin, such single aldehyde may be represented by k₁. The number of repeat units of k₁₊l+m is sufficient to provide the desired molecular weight. In this embodiment, k₂ and kₙ may be zero. The polyacetal resin is typically a random copolymer. However, block copolymers and tapered block copolymers may provide similar benefits as random copolymers.

The content of polyvinyl acetal (e.g. butyral) typically ranges from 65 wt-% up to 90 wt-% of the polyvinyl acetal (e.g. butyral) resin. In some embodiments, the content of polyvinyl acetal (e.g. butyral) ranges from about 70 or 75 up to 80 or 85 wt.-%. Thus, the number of repeat units of “k₁, k₂, . . . , kₙ” are selected accordingly.

The content of polyvinyl alcohol typically ranges from about 10 to 30 wt-% of the polyvinyl acetal (e.g. butyral) resin. In some embodiments, the content of polyvinyl alcohol ranges from about 15 to 25 wt-%. Thus, “l” is selected accordingly.

The content of polyvinyl acetate can be zero or range from 1 to 8 wt-% of the polyvinyl acetal (e.g. butyral) resin. In some embodiments, the content of polyvinyl acetate ranges from about 1 to 5 wt-%. Thus, “m” is selected accordingly.

In some embodiments, the alkyl residue of aldehyde comprises 1 to 7 carbon atoms. In other embodiments, the alkyl reside of the aldhehyde comprises 3 to 7 carbon atoms such as in the case of butylaldehyde (R₁=3), hexylaldehyde (R₁=5), n-octylaldehyde (R₁=7). Of these butylaldehyde, also known as butanal is most commonly utilized. Polyvinyl butyral (“PVB”) resin is commercially available from Kuraray under the trade designation “Mowital™” and Solutia under the trade designation “Butvar™”.

In some embodiments, the polyvinyl acetal (e.g. butyral) resin has a Tg ranging from about 60° C. up to about 75° C. or 80° C. In some embodiments, the Tg of the polyvinyl acetal (e.g. butyral) resin is at least 65 or 70° C. When other aldehydes, such as n-octyl aldehyde, are used in the preparation of the polyvinyl acetal resin, the Tg may be less than 65° C. or 60° C. The Tg of the polyvinyl acetal resin is typically at least 35, 40 or 45° C. When the polyvinyl acetal resin has a Tg of less than 60° C., higher concentrations of high Tg monomers may be employed in the film and (e.g. exemplified) composition in comparison to those utilizing polyvinyl butyral resin. When other aldehydes, such as acetaldehyde, are used in the preparation of the polyvinyl acetal resin, the Tg may be greater than 75° C. or 80° C. When the polyvinyl acetal resin has a Tg of greater than 70° C., higher concentrations of low Tg monomers may be employed in the film and (e.g. exemplified) composition in comparison to those utilizing polyvinyl butyral resin.

The polyvinyl acetal (e.g. PVB) resin typically has an average molecular weight (Mw) of at least 10,000 g/mole or 15,000 g/mole and no greater than 150,000 g/mole or 100,000 g/mole. In some favored embodiments, the polyacetal (e.g. PVB) resin has an average molecular weight (Mw) of at least 20,000 g/mole: 25,000:30,000, 35,000 g/mole and typically no greater than 75,000 g/mole.

One of ordinary skill in the art appreciates that another way to describe molecular weight of a polymer is solution viscosity. Polyvinyl acetal (e.g. PVB) polymer is commercially available at solution viscosities that range from about 10 to about 300 mPas of a 10 wt. % solution of the polymer in ethanol and 5% water. In some embodiments, the polyvinyl (e.g. butyral) polymer has a solution viscosity (of a 10 wt. % solution of the polymer in ethanol and 5% water) of at least 40, 50 or 60 MPas and no greater than 150, 140, 130, 120, or 100 MPas. A single polyvinyl (e.g. butyral) polymer may have this viscosity or a blend of two or more polyvinyl (e.g. butyral) polymers.

The second (e.g. core) layer comprises at least 50 wt. % polyvinyl acetal (e.g. butyral) polymer based on the total weight of organic polymer of the second layer. In some embodiments, the amount of polyvinyl acetal (e.g. butyral) polymer may be at least 60, 70, 80, 90 wt. % or greater based on the total weight of organic polymer of the second layer. As demonstrated in the forthcoming examples, the tape properties can be better when the second layer has higher concentrations of polyvinyl acetal.

The second polymer can be utilized to adjust the properties of the second layer. For example the second polymer of the second layer may have a lower tensile strength and/or higher elongation to improve the flexibility of the second layer. In some embodiments, the second polymer of the second layer has a tensile strength in a range from about 50 to 100 MPa. In some embodiments, the second polymer of the second layer has an elongation at break in a range from about 250 to 500% (as measured according to DIN 53504).

In some embodiments, the second core layer comprises a blend of polyvinyl acetal (e.g. butyral) polymer and a second thermoplastic polymer. In some embodiments, the second thermoplastic polymer is a thermoplastic polyurethane. The amount of second (e.g. polyurethane) polymer is typically no greater than 50 wt. %. In some embodiments, the amount of second (e.g. polyurethane) polymer is typically no greater than 40, 30, 20, or 10 wt. %. based on the total weight of organic polymer of the second layer.

The second layer, especially when formed from thermal coextrusion is typically a continuous layer, i.e. in the length and width of the adhesive articles. In some embodiments, the second layer is not a foam. In typical embodiments, the second layer lacks an epoxy component.

### Method of Making

The above-described curable compositions can be coated on a substrate using conventional coating techniques modified as appropriate to the particular substrate. For example, these curable compositions can be applied to a variety of solid substrates by methods such as roller coating, flow coating, dip coating, spin coating, spray coating knife coating, and die coating. The curable composition may also be coated from the melt. These various methods of coating allow the compositions to be placed on the substrate at variable thicknesses thus allowing a wider range of use of the compositions. Coating thicknesses may vary as required for a specific application.

The (e.g. tape) adhesive articles comprises at least two layers, a first adhesive layer and a second polyvinyl acetal-containing backing or carrier layer. In some embodiments, the second layer is disposed between the first layer and a third layer. The third layer may also comprise a thermoplastic (e.g. thermally extrudable) adhesive composition. In some embodiments, the third layer is the same curable adhesive as the first layer. Alternatively, the third layer may be a different adhesive composition.

The thickness of each layer is typically at least 5, 10, 15, 20, 25, 50, 75, 100, 125, 150, 175, or 200 microns and typically no greater than 1000 microns. When the second layer is formed from thermal coextrusion, the second layer is typically at least 100 microns. In some embodiments, the total thickness of the first and second layers is no greater than 2000, 1500, or 1000 microns.

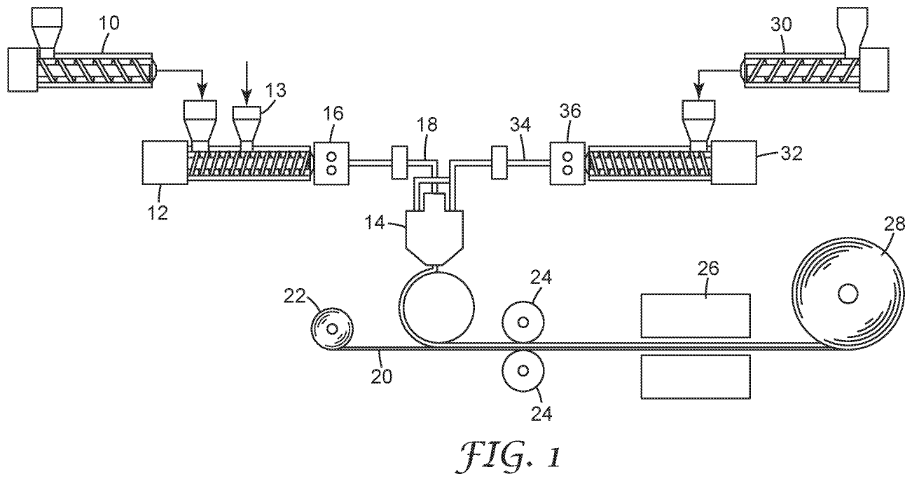

In one preferred embodiment, the adhesive article is prepared by thermal coextrusion of a first layer and a second layer. FIG. 1 is a schematic drawing of an extrusion process suitable for preparing multilayer articles. According to the process, the curable adhesive composition of the first layer is initially fed into a first extruder 10 (typically a single screw extruder) which softens and grinds the resin into small particles suitable for extrusion. The curable adhesive composition of the first layer may be added to extruder 10 in any convenient form, including pellets, billets, packages, strands, and ropes. Next, the curable adhesive composition of the first layer and optional additives are fed to a second extruder 12 (e.g., a single or twin screw extruder) at a point immediately prior to the kneading section of the extruder. Once combined, the curable adhesive composition and additives are fed to the kneading zone of extruder 12 where they are mixed well. The mixing conditions (e.g., screw speed, screw length, and temperature) are selected to achieve optimum mixing. Where no mixing is needed, e.g., where there are no additives, the kneading step may be omitted. In addition, where the curable adhesive composition is already in a form suitable for extrusion, the first extrusion step may be omitted and the curable adhesive composition added directly to extruder 12.

Following melt-mixing, the extrudable polyvinyl acetal composition is metered into extrusion die 14 (e.g., a contact or 15 drop die) through a length of transfer tubing 18 using a gear pump 16 that acts as a valve to control die pressure. The temperature within die 14 is preferably maintained at substantially the same temperature as the temperature within 20 transfer tubing 18. The flow rate of polyvinyl acetal composition through the extruder and the die exit opening are maintained such that as the polymer composition is processed through the die. The extrusion die may be a drop die, contact die, profile die, annular die, or a casting die, as known in the art. A tighter tolerance is defined as the machine (or longitudinal) direction and crossweb (or transverse) direction standard deviation of density or thickness over the average density or thickness (a/x), respectively. The a/x is typically less than about 0.2, less than about 0.1, less than about 0.05, and even less than about 0.025.

The polyvinyl acetal composition may optionally be combined with a liner 20 dispensed from a feed roll 22. Suitable materials for liner 20 include silicone release liners, polyester films (e.g., polyethylene terephthalate films), and polyolefin films (e.g., polyethylene films). The liner and polyvinyl acetal composition are then laminated together between a pair of nip rollers 24.

Following lamination or after being extruded but before lamination, the curable adhesive composition is optionally exposed to radiation from an electron beam source 26 to crosslink the curable adhesive. Other sources of radiation (e.g., ion beam, thermal and ultraviolet radiation) may be used as well. Crosslinking may also be accomplished by using chemical crosslinking methods based on ionic interactions. Suitable thermal crosslinking agents include epoxies and amines. Preferably, the concentrations are sufficiently low to avoid excessive crosslinking or gel formation before the composition exits the die. Crosslinking improves the cohesive strength of the adhesive composition. Following exposure, the laminate is rolled up onto a take-up roll 28.

If desired, the smoothness of one or both of the curable adhesive composition surfaces can be increased by using a nip roll to press the foam against a chill roll after the foam exits die 14. It is also possible to emboss a pattern on one or both surfaces of the curable adhesive composition by contacting the adhesive with a patterned roll after it exits die 14, using conventional microreplication techniques, such as, for example, those disclosed in U.S. Pat. No. 5,897,930 (Calhoun et al.), U.S. Pat. No. 5,650,215 (Mazurek et al.) and the PCT Patent Publication No. WO 98/29516A (Calhoun et al.), all of which are incorporated herein by reference. The replication pattern can be chosen from a wide range of geometrical shapes and sizes, depending on the desired use of the foam. The substantially smooth surface improves microreplication to a higher degree of precision and accuracy.

One or more curable adhesive compositions layers is combined with at least one second polyvinyl acetal layer. As shown in FIG. 1, polyvinyl acetal composition is added to a second extruder 30 (e.g., a single screw extruder) where it is softened and melt mixed. The melt composition is then fed to a second extruder 32 (e.g., a single or twin screw extruder). Following melt-mixing, the extrudable polyvinyl acetal composition is metered into extrusion die 14 (e.g., a contact or 15 drop die) through a length of transfer tubing 18 using a gear pump 36 that acts as a valve to control die pressure.

Additional layers (not shown) such as tie layers, primers layers or barrier layers also can be included to enhance the interlayer adhesion or reduce diffusion through the construction. In addition, interlayer adhesion of a construction having multiple layers of different compositions by blending a fraction of the composition of the first layer into the composition of the second layer.

The first and second layer are typically concurrently coextruded as shown in FIG. 1. In one embodiment (not shown), the second layer is coextruded between first and third adhesive layers. Alternatively, the first and second layer can be sequentially extruded, i.e. at least one layer is cooled and solidified prior to extrusion of another layer.

As known in the art, the extrusion process typically produces orientation due to stretching in the machine direction. Orientation conditions include the temperature, direction(s) of stretch, rate of stretch, and degree of stretch (i.e., orientation ratio).

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description |
|---|---|
| LA2330 | M-B-M acrylic block copolymer with a MFR of 3.7 g/10 min (ISO 1133, |
| | 190° C./2.16 kg), obtained under the trade designation “KURARITY LA2330” |
| | from Kuraray Co., Ltd., Tokyo, Japan |
| LA2140 | M-B-M acrylic block copolymer with a MFR of 31 g/10 min (ISO 1133, |
| | 190° C./2.16 kg), obtained under the trade designation “KURARITY LA2140” |
| | from Kuraray Co., Ltd., Tokyo, Japan |
| 828 | Difunctional bisphenol A/epichlorohydrin derived epoxy resin, obtained under |
| | the trade designation “EPON 828” from Dow Inc., Midland, Michigan |
| 1001 | Difunctional bisphenol A/epichlorohydrin derived epoxy resin, obtained under |
| | the trade designation “EPON 1001F” from Dow Inc., Midland, Michigan |
| 2200 | 2,000 molecular weight propylene oxide polyether diol with low mono-ol, |
| | obtained under the trade designation “ACCLAIM 2200” from CovestroAG, |
| | Luverkusen, Germany |
| OMICURE | An aromatic substituted urea obtained under the trade designation “OMICURE |
| | U-52M” from Huntsman Corporation, Woodlands, Texas |
| 6976 | A cationic UV photoinitiator containing a mixture |
| | of triarylsulfonium hexafluoroantimonate salts in propylene carbonate, obtained |
| | under the trade designation “UVI-6976” from Dow Inc., Midland, Michigan |
| ENR50 | Epoxidized natural rubber with 50% epoxide functional groups, obtained |
| | from Sanyo Corporation, New York, New York |
| 4454 | Polyacrylate elastomer which contains one or more acrylic esters with a small |
| | percentage of carboxy/chlorine cure sites, obtained under the trade designation |
| | “HYTEMP 4454” from ZEON Chemicals L.P., Louisville, Kentucky |
| D1119 | Kraton D1119 P is a clear, linear triblock copolymer based on styrene and |
| | isoprene with a polystyrene content of 22% from Kraton Polymers, Houston |
| | Texas |
| Q3620 | Polystyrene-polyisoprene synthetic rubber block copolymer, obtained under the |
| | trade designation “QUINTAC 3620” from ZEON Chemicals L.P., Louisville, |
| | Kentucky |
| 0432 | A cationic UV photoinitiator containing a mixture of triarylsulfonium |
| | hexafluorophosphate salts in propylene carbonate, obtained under the trade |
| | designation “Omnicat Q432” from IGM Resins Charlotte, NC |
| DUALITE | Expandable polymeric microspheres, obtained under the trade designation, |
| | “DUALITE U025-170D” from Chase Corp., Westwood, Massachusetts |
| IRG 1010 | Sterically hindered phenolic primary antioxidant, obtained under the trade |
| | designation, IRGANOX 1010” from BASF, Florham Park, New Jersey |
| PET1 | Silicone-coated polyester liner, obtained under the trade designation “SILPHAN |
| | S75 B 0R30032/0R30022” from Siliconature S.P.A., Godega di Sant′Urbano, |
| | Italy |
| PET2 | Silicone-coated polyester liner, obtained under the trade designation “SILPHAN |
| | S50 D 0R30022” from Siliconature S.P.A., Godega di Sant′Urbano, Italy |
| CE-1 | 0.2 mm black, acrylic foam tape, obtained under the trade designation “VHB |
| | Electronic Tape 86420” from 3M Company, St. Paul, Minnesota |
| CE-2 | 0.2 mm acrylic tape, obtained under the trade designation “VHB Tape 4914- |
| | 020” from 3M Company, St. Paul, Minnesota |
| 4013F | Low monol polyether polyol, can be obtained under the trade designation |
| | “PREMINOL S 4013F” from AGC Chemicals Americas, Inc., Exton, |
| | Pennsylvania |
| 250 | Cationic photoinitiator made of a blend of iodonium, (4-methylphenyl)[4- |
| | (2-methylpropyl) phenyl]-, hexafluorophosphate(1-) (75%) in propylene |
| | carbonate, obtained under the trade designation “OMNICAT 250” from IGM |
| | Resins USA Inc., Charlotte, North Carolina |
| ITX | 2-isopropylthioxanthone, obtained from Pfaltz and Bauer Inc., Waterbury, |
| | Connecticut |
| MMA | Methyl methacrylate, obtained from Alfa Aesar, Haverhill, Massachusetts |
| BA | Butyl acrylate, can be obtained from Millipore Sigma, St. Louis, Missouri |
| Ethyl Acetate | Ethyl acetate, can be obtained from Millipore Sigma, St. Louis, Missouri |
| VAZO 67 | 2,2′-azobis(2-methylbutanenitrile), can be obtained under the trade designation |
| | “VAZO 67” from The Chemours Company, Wilmington, Delaware |
| IOTG | Isooctyl thioglycolate, can be obtained from Millipore Sigma, St. Louis, |
| | Missouri |
| PI 2074 | 4-isopropyl-4′-methyldiphenyliodonium tetrakis(pentafluorophenyl)borate, a |
| | cationic photoinitiator obtained under the trade designation “BLUESIL PI |
| | 2074” from Elkem Silicones, East Brunswick, New Jersey |

Components of Core Layer Composition

| | |
|---|---|
| PN3429 | Thermoplastic polyurethane (ester-based) available from Huntsman as |
| | KRYSTALGRAN ™PB-3429-218 melt temperature 100-123, tensile strength |
| | MPa - 58, elongation at break - 450% (DIN 53504) |
| B30H | Polyvinyl butyral available from Kuraray as Mowital ™ 18-21% polyvinyl |
| | alcohol, 1-4% polyvinyl acetate, 30-60 mPas viscosity of 10 wt. % solution of |
| | ethanol and 5% water |
| B60H | Polyvinyl butyral 18-21% polyvinyl alcohol, 1-4% polyvinyl acetate, 160-260 |
| | Mpas viscosity of 10 wt. % solution of ethanol and 5% water |
| B45H | Polyvinyl butyral 18-21% polyvinyl alcohol, 1-4% polyvinyl acetate, 60-90 |
| | MPas viscosity of 10 wt. % solution of ethanol and 5% water |
| PolyOne | Carbon Black in ethylene-vinyl acetate obtained under the trade designation |
| | “Carbon Black 4105 Vac Black” from Polyone corporation Avon Lake, Ohio |

### Test Methods

### Gel Permeation Chromotography (GPC) Test Method

Samples were prepared in tetrahydrofuran (THF, stabilized with 250 ppm BHT) by weighing sample and solvent; the target concentration was approximately 3 milligrams/milliliter. The sample solution was then filtered through a 0.45 micrometer PTFE syringe filter and analyzed by GPC under the following conditions:
Instrument: Agilent 1260 LC
Column set: Waters Styragel HR 5E, 300×7.8 mm I.D.
Col. Heater: 40° C.
Mobile phase: THF (stabilized with 250 ppm BHT) at 1.0 mL/min
Injection volume: 30 microliters
Detector(s): Wyatt DAWN HELEOS-II 18 angle Light Scattering detector
   Wyatt Optilab T-rEX Differential Refractive Index (DRI) detector

Molecular weight results from GPC were determined using light scattering detection in THF eluent and ASTRA 6 from Wyatt Technology Corporation was used for data collection and analysis. The differential refractive index increment (dn/dc) of each sample was experimentally determined in the mobile phase or eluent using a Total Recovery Approach. Results are averages from duplicate injections and all dn/dc values are in mL/g. The experimental dn/dc values were used for molecular weight calculations.
Mₙ=Number-average molecular weight
M_{w}=Weight-average molecular weight
Ð=Dispersity=M_{w}/Mₙ

Samples for peel adhesion and static shear adhesion testing were prepared by laminating the UV-curable pressure sensitive adhesive tape onto 0.13 mm thick anodized aluminum foil using a hand held rubber roller, except where noted. The test tape was irradiated with 4 J/cm2 (at ca. 1.1 W/cm2) from a 365 nm AC7300 LED light source (Excelitas Technologies, Waltham, MA, USA). The total UVA energy was determined using a POWER PUCK II radiometer equipped with a high power sensing head (available from EIT Incorporated, Sterling, VA). Stainless steel substrates were cleaned with methyl ethyl ketone, 1:1 isopropanol/water, acetone, and then dried with a KIMWIPE (Kimberly-Clark, Irving, TX) unless otherwise noted.

### Peel Adhesion

A 12.5 mm wide strip of adhesive tape was applied to anodized aluminum foil, UV-activated, then laminated onto a 1.6 mm thick stainless steel panel using a 2.0 kg rubber roller to give a bonded article. The article was allowed to dwell for 72 hr at CTH conditions. A 90° angle peel test was performed using an MTS Sintech 500/S at 30.5 cm/min peel rate, with data collected and averaged over 10 seconds, according to the test method ASTM Designation D3330/D330M-04. Uncured peel adhesion samples were prepared as above, except the UV-exposure step was skipped.

### Static Shear Adhesion

Static Shear Adhesion was determined according to the test method of ASTM D3654/D3654M-06. A 25.4×12.7 mm UV-cured adhesive tape was applied to anodized aluminum foil, UV-activated, then laminated onto a 1.6 mm thick stainless steel panel using a 2.0 kg rubber roller to give a bonded article. The article was allowed to dwell for 24 hours before a 0.5 kg weight was attached to the assembly by the remaining length of aluminum foil that extended beyond the bonded area and held at 70° C. The time was measured when the adhesive sample failed to hold the weight. Samples were stopped at 10,000 min if they did not fail sooner.

### Push Out Strength

A test tape sample with siliconized PET liners on both surfaces was cut in a circular ring geometry with a 3.11 cm outer diameter, 2.61 cm inner diameter (2.5 mm bond width). One liner was removed exposing the adhesive surface and the tape was adhered to the surface of a square polycarbonate test frame (4.07×4.07×0.3 cm) with a circular hole (2.4 cm diameter) cut in the middle; wherein the tape is centered over the hole. The second liner was removed from the test tape and the tape was irradiated with 4 J/cm2 of 365 nm UV-LED light. The total UVA energy was determined using a POWERPUCK II radiometer equipped with a high power sensing head (available from EIT Incorporated, Sterling, VA). Immediately after irradiation, a polycarbonate circular puck (3.3 cm diameter×0.3 cm thick) was centered over the test tape and adhered to the polycarbonate frame surface using a 10 kg weight which was placed on the bonded polycarbonate puck, tape, polycarbonate frame article for 10 seconds. The weight was removed and the testing fixture was allowed to dwell for 24 hr at CTH. An MTS Sintech 500/S (MTS, Eden Prairie, MN) was then used to separate the puck from the frame, which was held stationary, using a probe through the hole of the frame at a rate of 10 mm/min and the total force was recorded and three replicates were completed for each sample.

### Tensile Impact

Samples were prepared as described in the Push Out Strength method, except the frame and puck substrates were made of stainless steel instead of polycarbonate. The samples were tested at a drop height of 300 mm with a 3 kg mass using an Instron CEAST 9340 Drop tower, wherein the impact was through the hole in the stationary frame such that the puck was separated from the frame. The total energy and failure mode were recorded and three replicates were completed for each sample.

### Dynamic Shear

A stainless steel substrate (25.4×76.2×1.6 mm) was cleaned with methyl ethyl ketone, 1:1 isopropanol/water, acetone, and then dried with a KIMWIPE (Kimberly-Clark, Irving, TX). A 1″ by 1″ tape sample with PET liner on one surface was firmly bonded to the stainless steel substrate opposite the PET liner using finger pressure. The PET liner was then removed. The test tape was irradiated with 4 J/cm2 of 365 nm UV-LED light. The total UVA energy was determined using a POWER PUCK II radiometer equipped with a high power sensing head (available from EIT Incorporated, Sterling, VA). A second clean stainless steel substrate was bonded to the UV-cured tape. The sample was mechanically rolled with a 6.8 kg roller at 305 mm/min to ensure proper adhesion. The sample was allowed to dwell for 24 hr at CTH conditions. The substrates were attached to two separated jaw hooks in an MTS Insight 30 (MTS, Eden Prairie, MN) and separated at a rate of 12.7 mm/min.

### Gel Content

All samples were cut out using a 2.54 cm diameter die, weighed, and then put into a pre-weighed metal pouch. The pouch was submerged in THF for three days. Pouches were taken out of solvent to dry in for 4 h in a 120° C. solvent oven (Blue M model DC-246AG-HP). The samples were then weighed again and the change in weight was recorded.

### Tensile Dynamic Mechanical Analysis

Samples were cured and laminated to a caliper of 800 μm then cut into a 6.35 mm strip and placed on the TA instruments Q800 DMA. The strip was oscillated at 1 Hz with a 2% strain using a temperature ramp from −60° C. to 150° C. at a heating rate of 2° C./min.

### Shear Rheology

Shear rheology was measured using a Discovery Hybrid parallel plate rheometer (TA Instruments) to characterize the physical properties of each sample as a function of temperature. Rheology samples were prepared by punching out a section of the PSA with an 8 mm circular die, removing it from the release liners, centering it between 8 mm diameter parallel plates of the rheometer, and compressing until the edges of the sample were uniform with the edges of the top and bottom plates. The furnace doors that surround the parallel plates and shafts of the rheometer were shut and the temperature was equilibrated at 20° C. and held for 1 minute. The temperature was then ramped from 20° C. to 125 or 130° C. at 3° C./min while the parallel plates were oscillated at an angular frequency of 1 Hertz and a constant strain of 5 percent.

### Preparatory Example

### Synthesis of Preparatory Example 1 (PE1)

Methyl methacrylate (11 grams) was combined with butyl acrylate (39 grams) in a 200 mL glass jar equipped with a stir bar. Ethyl acetate (100 grams), IOTG (0.075 grams), and VAZO 67 (0.05 grams) were then added and the solution was purged by bubbling nitrogen through the solution for a period of 5 minutes, and then a lid was placed on the jar. The jar was placed in a water bath set to 70° C. on a stir plate for a period of 24 h. Solvent and residual monomer were removed by a vacuum oven set to 40° C. at a pressure of −30 in Hg.

### Examples

Examples CE-3 and EX-1 to EX-4 in Table 2 were prepared by combining the listed materials in a jar and rolling for 24 hours prior to coating. Tapes were prepared by pouring the solution onto PET1 then passed under a notch bar coater set with a gap of 24 mil (610 μm). The tape was then placed in a vented oven (Blue M model DC-246AG-HP) set to 70° C. for a period of 5 minutes. Two layers of each tape were laminated together to make a thicker sample.

TABLE 2
Compositions of UV-Activated Tapes for Investigating
the Effect of Polyol Concentration

| | Final | LA2330 | 828 | 2200 | 6976 | Toluene |
|---|---|---|---|---|---|---|
| Example | Thickness (mm) | (wt. %) | (wt. %) | (wt. %) | (wt. %) | (wt. %) |
| CE-3 | 0.36 | 24.8 | 24.8 | 0.0 | 1.0 | 49.5 |
| EX-1 | 0.39 | 24.8 | 19.8 | 5.0 | 1.0 | 49.5 |
| EX-2 | 0.39 | 24.8 | 17.3 | 7.4 | 1.0 | 49.5 |
| EX-3 | 0.39 | 24.8 | 14.9 | 9.9 | 1.0 | 49.5 |
| EX-4 | 0.39 | 24.8 | 12.4 | 12.4 | 1.0 | 49.5 |

Examples EX-5 to EX-11 in Table 3 were prepared using a batch twin screw extruder with the following settings:
Extruder and melt train temperature: 250° F. (121° C.)
Hose and die temperature: 280° F. (138° C.)
Screw speed: 150 rpm
   Upon exiting the die, the melt was coated on PET1 liner. The samples were then wound into a roll. Extruded samples were 80-145 μm thick transfer tapes. These tapes were then laminated up to double the thickness to between 160-290 μm.

TABLE 3
Compositions of UV-Activated Tapes Made Using a Batch Twin Screw Extruder

| | Final | | | | | | | | | IRG |
|---|---|---|---|---|---|---|---|---|---|---|
| Example | Thickness (mm) | LA2330 | LA2140 | 828 | 2200 | 6976 | ENR50 | 4454 | Q3620 | 1010 |
| EX-5 | 200 | 39.0 | 0.0 | 29.3 | 29.3 | 2.0* | 0.0 | 0.0 | 0.0 | 0.5 |
| EX-6 | 250 | 39.0 | 0.0 | 29.3 | 29.3 | 2.0 | 0.0 | 0.0 | 0.0 | 0.5 |
| EX-7 | 180 | 0.0 | 39.0 | 29.3 | 29.3 | 2.0 | 0.0 | 0.0 | 0.0 | 0.5 |
| EX-8 | 200 | 29.3 | 0.0 | 29.3 | 29.3 | 2.0 | 0.0 | 9.8 | 0.0 | 0.5 |
| EX-9 | 160 | 19.5 | 0.0 | 29.3 | 29.3 | 2.0 | 0.0 | 19.5 | 0.0 | 0.5 |
| EX-10 | 290 | 29.3 | 0.0 | 29.3 | 29.3 | 2.0 | 9.8 | 0.0 | 0.0 | 0.5 |
| EX-11 | 250 | 29.3 | 0.0 | 29.3 | 29.3 | 2.0 | 0.0 | 0.0 | 9.8 | 0.5 |

*PI 2074/ITX (1:1) was used instead of CPI 6976

Examples EX-12 to EX-19 in Table 4 were prepared using a 12-zone, continuous hot melt extruder with the average temperature of 250° F. (121° C.) and a screw speed of 500 rpm.
Upon exiting the die, the melt was coated on PET1 liner and then laminated with PET2 liner. The samples were then wound into a roll.

TABLE 4
Compositions of UV-Activated Tapes Made Using a Continuous Twin Screw Extruder

| | Final | | | | | | IRG | | |
|---|---|---|---|---|---|---|---|---|---|
| Example | Thickness (mm) | LA2330 | 828 | 2200 | 6976 | 1001 | 1010 | Q3620 | DUALITE |
| EX-12 | 200 | 29.1 | 29.1 | 29.1 | 1.9 | | 1.0 | 9.7 | 0.0 |
| EX-13 | 250 | 38.8 | 29.1 | 29.1 | 1.9 | | 1.0 | 0.0 | 0.0 |
| EX-14 | 180 | 48.5 | 24.3 | 24.3 | 1.9 | | 1.0 | 0.0 | 0.0 |
| EX-15 | 200 | 34.0 | 29.1 | 29.1 | 1.9 | | 1.0 | 4.9 | 0.0 |
| EX-16 | 160 | 38.5 | 28.8 | 28.8 | 1.9 | | 1.0 | 0.0 | 1.0 |
| EX-17 | 290 | 48.1 | 24.0 | 24.0 | 1.9 | | 1.0 | 0.0 | 1.0 |
| EX-18 | 250 | 33.7 | 28.8 | 28.8 | 1.9 | | 1.0 | 4.8 | 1.0 |
| EX-19 | 210 | 50 | 22 | 8 | 2 | 20 | 1.0 | | |

Examples EX-20 and CE-4 in Table 5 were prepared by combining the listed materials in a jar and rolling for 24 hours prior to coating. Tapes were prepared by pouring the solution onto PET1 then passed under a notch bar coater set with a gap of 24 mil (610 μm). The tape was then placed in a vented oven (Blue M model DC-246AG-HP) set to 70° C. for a period of 5 minutes. Two layers of each tape were laminated together to make a thicker sample.

TABLE 5
Preparation of Tapes for Comparing Random to Block Acrylic Copolymers

| | Final | | | | | | | |
|---|---|---|---|---|---|---|---|---|
| Example | Thickness (mm) | LA2330 | PE1 | 828 | 4013F | ITX | 250 | Q3620 |
| EX-20 | 200 | 34.0 | 0.0 | 29.1 | 29.1 | 1.0 | 1.9 | 4.9 |
| CE-4 | 250 | 0.0 | 34.0 | 29.1 | 29.1 | 1.0 | 1.9 | 4.9 |

TABLE 6
Adhesion Properties of UV-Activated Tapes

| | 90° Peel Adhesion | | Static | Dynamic | Push Out | Tensile | Gel |
|---|---|---|---|---|---|---|---|
| | (lbs/in width) | | Shear | Shear | Strength | Impact | Content |
| Example | Uncured | Cured | (min) | (N/mm) | (N) | Strength(J) | (% Wt. Loss) |
| CE-1 | | | 3100 | 1.18 | 168 | 1.01 | |
| CE-2 | | | >10,000 | 1.25 | 274 | 0.37 | |
| CE-3 | | | | | | | 93 |
| EX-1 | | | >10,000 | | 819 | | 83 |
| EX-2 | | | >10,000 | | 865 | | 74 |
| EX-3 | | | >10,000 | | 709 | | 66 |
| EX-4 | | | >10,000 | | 585 | | 50 |
| EX-5 | | | >10,000 | | 109 | | |
| EX-6 | | | >10,000 | 1.91 | 465 | 0.83 | |
| EX-7 | | | >10,000 | 2.14 | 577 | 1.24 | |
| EX-8 | | | >10,000 | 2.12 | 382 | 1.27 | |
| EX-9 | | | >10,000 | 0.54 | 73 | 1.09 | |
| EX-10 | | | >10,000 | 2.94 | 201 | 0.87 | |
| EX-11 | | | >10,000 | 3.09 | 667 | 1.80 | |
| EX-12 | 1.24 | 9.32 | >10,000 | 2.03 | 239 | 1.16 | |
| EX-13 | 3.79 | 11.13 | >10,000 | 2.00 | 231 | 0.68 | |
| EX-14 | 5.11 | 10.54 | >10,000 | 1.28 | 138 | 0.51 | |
| EX-15 | 1.78 | 9.33 | >10,000 | 1.91 | 271 | 1.05 | |
| EX-16 | 2.82 | 8.85 | >10,000 | 2.33 | 138 | 0.55 | |
| EX-17 | 7.29 | 10.07 | >10,000 | 2.88 | 233 | 0.58 | |
| EX-18 | 2.05 | 9.12 | >10,000 | 2.47 | 271 | 0.99 | |
| EX-19 | 3.39 | | >10,000 | 7.32 | 1041 | 0.194 | |
| EX-20 | | | >10,000 | 0.97 | 318 | 0.46 | |
| CE-4 | | | 0 | 0.15 | 50 | 0.45 | |

TABLE 7
Rheology Data for Select UV-Activated Tapes

| | Cured E′ at 23° C. | Cured Tan(δ) max |
|---|---|---|
| Example | (pa) | (° C.) |
| CE-3 | 4.50E+08 | 128 |
| EX-1 | 4.75E+08 | 81 |
| EX-2 | 3.37E+08 | 57 |
| EX-3 | 8.32E+07 | 40 |
| EX-4 | 6.17E+06 | 21 |
| EX-12 | 3.70E+06 | 14 |
| EX-13 | 2.93E+06 | 19 |
| EX-14 | 2.60E+06 | 30 |
| EX-15 | 3.67E+06 | 17 |

Epoxidized natural rubber ENR50 solutions were prepared by masticating the ENR50 with an extruder with a screw rate of 400 rpm for 4 minutes and then dissolving in toluene to obtain a 35 wt. % solution. The ENR50 solution was combined with 828, D1119, and curing catalyst as shown in Table 8. The materials were coated at a 12 mil wet gap onto the silicone surface of PET1 liner using a notch bar and dried at 74° C. (165° F.) for a period of 9 minutes. After drying the silicone surface of PET1 liner was laminated to make an adhesive transfer tape. 10

TABLE 8
Curable Adhesive Tapes with Epoxidized Natural Rubber,
Styrenic Block Copolymer, and Epoxy Resin

| | | | | | | Uncured Peel | Cured Peel |
|---|---|---|---|---|---|---|---|
| Example | ENR50 | 828 | D1119 | OMICURE | 6976 | (N/cm) | (N/cm) |
| EX-21 | 50 | 8.75 | 0.0 | 4.3 | 0.0 | 1.67 | 40.3 |
| EX-22 | 107 | 50 | 0.0 | 0.0 | 0.5 | 4.72 | 29.7 |
| EX-23 | 35.71 | 50 | 37.5 | 7 | 0.0 | 0.04 | 20.0 |
| EX-24 | 71.43 | 50 | 25 | 7 | 0.0 | 2.91 | 33.7 |
| EX-25 | 107.14 | 50 | 12.5 | 7 | 0.0 | 5.28 | 36.4 |

TABLE 9
Core Composition of Multilayer Tape

| | Layer 1 Composition | | | | |
|---|---|---|---|---|---|
| Example | PN3429 | B30H | B60H | B45H | PolyOne |
| EX-26 | 32 | 64 | | | 3 |
| EX-27 | 17 | 81 | | | 1.4 |
| EX-28 | | 50 | 50 | | 0 |
| EX-29 | | | | 96 | 4 |

TABLE 10
Adhesive Compositions of Multilayer Tape

| | Layer 2 Composition | | | | | |
|---|---|---|---|---|---|---|
| Example | LA2330 | 828 | 1001 | 2200 | O432 | Q3620 |
| EX-26 | 50 | 17.5 | 10 | 17.5 | 2 | 5 |
| EX-27 | 67.6 | 11.8 | 13.5 | 13.5 | 2 | 6.7 |
| EX-28 | 61.7 | 10.7 | 9.3 | 9.3 | 2 | 6 |
| EX-29 | 50 | 22.5 | 12.5 | 12.5 | 2 | 5 |

The materials of Table 9 were prepared using a 10-zone, continuous hot melt extruder with the average temperature of 250° F. (121° C.) and a screw speed of 500 rpm. The materials of Table 10 were compounded in a separate continuous hot melt extruder set to 360° F. and a screw speed of 200 rpm. The outputs from the two extruders were combined into a 3-layer die set to 200° F. Upon exiting the die, the melt was coated on PET1 liner and then laminated with PET2 liner. The samples were then wound into a roll. The line speed was adjusted as needed to achieve the desired total construction caliper of 600 μm, with each individual layer being 200 μm.

The resulting tape was tested using the test methods previously described. The test result are as follows:

TABLE 11
Multilayer Tape Test Results
Multi-Layer Adhesive Properties

| | Dynamic | Push Out | Tensile Impact |
|---|---|---|---|
| | Shear | Strength | Strength |
| Example | (N/mm) | (N) | (J) |
| EX-26 | 1.05 | | |
| EX-27 | 0.67 | | |
| EX-28 | 3.29 | 201 | 0.49 |
| EX-29 | 4.9 | 506 | 0.47 |

The adhesive compositions of Examples 1-24 can also be disposed on a layer comprising polyvinyl acetal (e.g. by thermal coextrusion) in the same manner.

1. An article comprising a first layer comprising a curable adhesive composition, wherein the curable adhesive composition comprises:
20 wt. % to 60 wt. % of an acrylic block copolymer;
5 wt. % to 60 wt. % of an epoxy resin; and
1 wt. % to 60 wt. % of a polyol; and
the first layer is disposed on a second layer comprising polyvinyl acetal polymer.

2. The article of claim 1 wherein the second layer comprise at least 50, 60, 70, 80, or 90 wt. % of polyvinyl acetal polymer(s).

3. The article of claim 1 wherein the first and second layer independently have a thickness in the range of 5 to 1000 microns.

4. The article of claim 1 wherein the second layer is disposed between the first layer and a third layer and the third layer comprises a thermoplastic adhesive composition.

5. The article of claim 1 wherein the third layer is the same curable adhesive as the first layer.

6. The article of claim 1 wherein the acrylic block copolymer comprises 7 wt. % to 51 wt. % of a hard block and 49 wt. % to 93 wt. % of a soft block.

7. The article of claim 6 wherein the hard block comprises polymethyl methacrylate.

8. The article of claim 6 wherein the soft block comprises polybutyl acrylate.

9. The article of claim 1 wherein the acrylic block copolymer has a number average molecular weight of 48 kD to 102 kD, or 65 kD to 101 kD, or 75 kD to 100 kD.

10. The article of claim 1 wherein the epoxy resin has an epoxy equivalent weight of from 150 to 250.

11. The article of claim 1 wherein the epoxy resin comprises a first epoxy resin and a second epoxy resin combined in a ratio of 0.5:1.5, or 0.75:1.25, or 1:1.

12. The curable composition of claim 11 wherein a second epoxy resin has an epoxy equivalent weight of from about 500 to about 600.

13. The curable composition of claim 1 wherein the epoxy resin comprises a bisphenol A derived epoxy resin.

14. The curable composition of claim 1 wherein the polyol has a molecular weight of 500 g/mol to 14,000 g/mol.

15. The curable composition of claim 1 wherein the polyol comprises a polyether polyol, a polyester polyol, and combinations thereof.

16. The curable composition of claim 1 further comprising a curing agent selected from the group consisting of an amine curing agent, a photoinitiator, and combinations thereof.

17. The article of claim 1 wherein the adhesive composition is cured and has
an impact strength of 0.4 to 1.8 Joules as measured by Tensile Impact test method;
a push out strength of 50 to 1040 Joules as measured by Push Out Strength test method;
a dynamic shear of 0.5 to 7.32 MPa as measured by Dynamic Shear test method;
or a combination thereof.

18-19. (canceled)

20. An article comprising a first layer comprising a curable adhesive composition, wherein the curable adhesive composition comprises:
a thermoplastic polymer; and
epoxy resin; and
the first layer is disposed on a second layer comprising at least 50 wt. % polyvinyl acetal polymer.

21. (canceled)

22. A curable adhesive composition, wherein the curable adhesive composition comprises:
20 wt. % to 60 wt. % of an acrylic block copolymer;
5 wt. % to 60 wt. % of an epoxy resin; and
1 wt. % to 60 wt. % of a polyol; and
optional additives.

23. (canceled)
